(19) United States
(12) Patent Application Publication
(10) Pub. No.: US 2005/0192392 A1
(43) Pub. Date: Sep. 1, 2005

(54) Adhesives having advanced flame-retardant property

(75) Inventors: Jang Soon Kim, Daejeon (KR); Woo Ha Kim, Gangwon-do (KR); Jae Gwan Lee, Daejeon (KR); Suk Ky Chang, Daejeon (KR); Wook Kim, Seoul (KR); Geun Hee Lee, Chungcheongbuk-do (KR); Byoung Soo Lee, Seoul (KR)

Correspondence Address: BIRCH STEWART KOLASCH & BIRCH, PO BOX 747, FALLS CHURCH, VA, 22040-0747, US

(73) Assignee: LG Chem, Ltd., Seoul (KR)

(21) Appl. No.: 10/986,654

(22) Filed: Nov. 12, 2004

(30) Foreign Application Priority Data
Nov. 13, 2003 (KR) 10-2003-0080161

(51) Int. Cl. C08K 3/10

(52) U.S. Cl. 524/436; 524/437

(57) ABSTRACT

The present invention provides an adhesive comprising an acrylic polymer resin and a flame-retardant filler, in which the content of unreacted residual monomers in the adhesive, which are parts of monomers for forming the acrylic polymer resin and remain unreacted after a preparation process of the adhesive, is 2% or less by weight. Also, the present invention provides an adhesive sheet formed by applying the adhesive to one or both sides of a substrate. In addition, the present invention provides a method of controlling the flame retardancy of the adhesive by adjusting the content of the unreacted residual monomers in the adhesive.

### TECHNICAL FIELD

The present invention relates to an adhesive excellent in flame retardancy, thermal conductivity and/or adhesion strength, and a preparation method thereof. Also, the present invention relates to a method of controlling the flame retardancy of an adhesive.

### BACKGROUND ART

With the recent development of the electrical/electronic industries, the technology of attaching electronic parts, such as plasma display panels, becomes very important. Adhesives are used to attach electronic parts, and recently, thermally conductive adhesives comprising thermally conductive inorganic particles dispersed in a adhesive polymer are generally used.

The thermally conductive adhesives contain a thermally conductive filler. The polymer in the adhesives provides the adhesion strength between substrates, and the thermally conductive inorganic particles added as the filler act to transfer heat generated in electrical/electronic parts to a heat dissipating plate (heat sink). As the polymer, an acrylic, polyurethane or silicone resin is used, and as the thermally conductive inorganic particles, aluminum oxide, aluminum hydroxide, calcium carbonate, boron nitride, aluminum nitride, silicon carbide and the like are frequently used, which have thermal conductivity and at the same time, are electrically insulating.

Meanwhile, in order to prevent the risk of a fire which can occur due to high heat generated in electrical/electronic parts, recently developed adhesives frequently have flame retardancy in addition to adhesion strength and thermal conductivity. As flame-retardants for imparting flame retardancy to adhesives, halogen flame-retardants were widely used in the prior art, but are limited in use due to the problem of environmental contamination. Currently, a variety of halogen-free flame-retardants are developed and used.

Japanese Patent Laid-Open Publication No. H 11-269438 discloses adhesives comprising thermally conductive fillers, such as metal oxide, metal nitride, metal hydroxide, etc., and halogen-free organic flame-retardants containing both phosphorus and nitrogen. However, in the case of using halogen-free organic flame retardants containing both phosphorus and nitrogen, such as ammonium phosphate or melamine phosphate, there is a limitation in that thermally conductive inorganic fillers are incorporated in order to achieve the desired thermal conductivity. Additionally, there is a problem in that an excess of the flame retardants need to be used to secure flame retardancy in spite of the fact that the use of an excess of the flame retardants results in deterioration in the physical properties of adhesives. Also in this case, there is a problem in that the viscosity of slurry increases greatly due to a reaction between the polymer resin and the flame retardant particles, thus causing problems in processes, such as coating and molding processes, and at the same time, a reduction in adhesion strength.

Japanese Patent Laid-Open Publication No. 2002-294192 discloses an adhesive for heat sink sheets, comprising aluminum oxide as a thermally conductive filler, and aluminum hydroxide with a smaller particle diameter than that of the aluminum oxide, as a flame retardant. According to this publication, it is preferred that the particle diameter of the thermally conductive filler is 50-120 μm, and the particle diameter of the flame retardant is 1-50 μm. It is generally known that a flame-retardant particle diameter larger than 50 μm results in not only a reduction in the thermal conductivity of an adhesive but also a reduction in the flame retardant efficiency due to a decrease in the surface area of the flame retardant particles. It is thus understood that the particle diameter of the flame retardant in this publication is limited to the above range for this reason. In this case, however, the use of expensive aluminum oxide as the thermally conductive filler is required to achieve high thermal conductivity. In addition, since aluminum hydroxide as the flame retardant needs to be added together with the thermally conductive filler aluminum oxide, the amount of aluminum hydroxide which can be added is limited so that a great increase in flame retardancy cannot be achieved.

Due to the above-described problems occurring in the prior art, there is now a need for the research and development of adhesives which are excellent in thermal conductivity, flame retardancy and adhesion strength without causing an environmental contamination problem.

Meanwhile, it is known that unreacted residual monomers in adhesives either cause bad smells while they are released by heat generated in the use of the adhesives on electronic parts, or cause contamination by the released gas. Accordingly, studies to minimize the content of the unreacted residual monomers in adhesives are now conducted. However, there is still no disclosure of the relation between the content of the unreacted residual monomers and the flame retardancy of adhesives.

### DISCLOSURE OF THE INVENTION

### TECHNICAL SUBJECT

Accordingly, the present inventors have conducted studies to develop an adhesive which is not only excellent in thermal conductivity, flame retardancy and adhesion but also low in cost. Furthermore, the present inventors have conducted studies on a method for effectively controlling the flame retardancy of the adhesive.

As a result, the present inventors have found that, in an adhesive comprising an acrylic polymer resin and a flame retardant filler or a thermally conductive flame retardant filler, the content of unreacted residual monomers, which are parts of monomers for forming the acrylic polymer resin and remain unreacted after the preparation of the adhesive, has a relation with the flame retardancy of the adhesive.

Moreover, the present inventors have found that the content of the unreacted residual monomers in the adhesive is influenced by the kind and amount of materials used in the production of the adhesive, and by the preparation conditions, particularly by the irradiation intensity and time of ultraviolet light.

On the basis of these findings, the present inventors have invented an adhesive excellent in thermal conductivity, flame retardancy and adhesion strength.

Also, the present inventors have invented a method allowing the flame retardancy of a flame retardant-containing adhesive to be effectively controlled.

### TECHNICAL SOLUTION

The present invention provides an adhesive comprising an acrylic polymer resin and a flame-retardant filler, in which the content of unreacted residual acrylic monomers in the adhesive, which are parts of monomers for forming the acrylic polymer resin and remain unreacted after a preparation process of the adhesive, is 2% or less than 2% by weight. To impart thermal conductivity to the adhesive, a thermally conductive filler may be added. Preferably, a flame retardant filler with thermal conductivity may be used to impart both thermal conductivity and flame retardancy to the adhesive.

An adhesive imparted with thermal conductivity in addition to adhesion strength by the addition of a thermally conductive filler is referred to as a “thermally conductive adhesive”. In addition, the adhesive of the present invention may also be said to be a “pressure-sensitive adhesive” since it shows adhesion property by disposing the adhesive and applying pressure to the adhesive.

Accordingly, the present invention also provides a thermally conductive adhesive with improved flame retardancy. Preferably, the adhesive of the present invention is a pressure-sensitive adhesive.

In another aspect, the present invention provides an adhesive sheet formed by applying the adhesive of the present invention to one or both sides of a substrate.

In still another aspect, the present invention provides a method of preparing an adhesive, in which the content of unreacted residual monomers in the adhesive, which are parts of monomers for forming the acrylic polymer resin and remain unreacted after a preparation process of the adhesive, has been controlled to 2% or less by weight, the method comprising irradiating ultraviolet light with an intensity of 0.01-50 mW/cm² to a mixture of monomers for forming the acrylic polymer resin and a flame-retardant filler, for 30 seconds to 1 hour. Preferably, the flame-retardant filler is a thermally conductive flame-retardant filler, and the adhesive is a thermally conductive adhesive.

In yet another aspect, the present invention provides a method of controlling the flame retardancy of an adhesive comprising an acrylic polymer resin and a flame-retardant filler, the method comprising, in a preparation process of the adhesive, controlling the content of unreacted residual monomers in the adhesive, which are parts of monomers for forming the acrylic polymer resin and remain unreacted after a preparation process of the adhesive. This method allows flame retardancy to be selectively imparted to each adhesive to the desired extent.

Hereinafter, the present invention will be described in detail.

The adhesive of the present invention can be prepared by mixing monomers for forming an acrylic polymer resin with a flame-retardant filler or a thermally conductive flame-retardant filler, and polymerizing the mixture.

Preferably, the adhesive of the present invention can be prepared by partially polymerizing monomers for forming an acrylic polymer resin, mixing a flame-retardant filler or a thermally conductive flame-retardant filler with the partially polymerized monomers, and polymerizing and crosslinking the mixture.

In the polymerization step, some of the monomers for forming the acrylic polymer resin remain unreacted in the adhesive. Of the monomers for forming the acrylic polymer resin, the unreacted residual monomers in the adhesive are referred to as the “unreacted residual monomers” herein.

The present inventors have found that these unreacted residual monomers have strong volatility and thus influence the flame retardancy of the adhesive upon burning. On the basis of this finding, the present inventors have found that the flame retardancy of the adhesive can be improved by controlling the content of the unreacted residual monomers in the adhesive to 2% or less by weight.

The kind of a flame retardant which is added to provide flame retardancy to the adhesive of the present invention is not specifically limited. Preferably, as the flame-retardant filler, a thermally conductive flame-retardant filler may be used to impart both thermal conductivity and flame retardancy to the adhesive. If the flame-retardant filler is not the thermally conductive flame-retardant filler, a separate thermally conductive filler may be used.

Thermally conductive flame-retardant fillers which can be used in the present invention include metal hydroxides, for example, aluminum hydroxide, magnesium hydroxide, and calcium hydroxide. Among them, the most preferred is aluminum hydroxide.

In the present invention, the content of the thermally conductive flame-retardant filler is preferably 80-150 parts by weight to the 100 parts by weight of the acrylic polymer resin. That is, an excessive increase in the content of the thermally conductive flame-retardant filler leads to an increase in the surface area of the flame-retardant filler particles, resulting in increases in flame retardancy and thermal conductivity, but will make the adhesive excessively hard and lower the adhesion strength of the adhesive. On the other hand, a reduction in the content of the thermally conductive flame-retardant filler will result in reductions in the cohesion and thermal conductivity of the adhesive.

Meanwhile, thermally conductive flame-retardant fillers with small particle diameter can provide excellent flame retardancy, but cause an increase in the viscosity of slurry in the preparation of the adhesive, thus reducing the processability of the adhesive such as coating property. This also results in a reduction in the flexibility of the adhesive, thus making it difficult to apply the adhesive to a substrate having a rough surface. Thermally conductive flame-retardant fillers with excessively large particle diameter can result in an increase in the flexibility of the adhesive and provide excellent thermal conductivity, but can cause the problem of particle precipitation in the sheet-making or curing processes, resulting in a difference in the adhesion strength on each sides of the adhesive sheet. Accordingly, it is preferred in the present invention that the particle diameter of the thermally conductive flame-retardant filler is 50-150 μm.

As described above, it was known in the prior art that flame retardants with a particle size of more than 50 μm not only damage the thermal conductivity of adhesives but also lead to a reduction in the surface area of the flame-retardant particles resulting in a reduction in flame-retardant efficiency. However, if the content of the unreacted residual monomers in the adhesive is controlled to 2% or less by weight as described in the present invention, sufficient flame retardancy can be secured even when flame-retardant fillers with a particle diameter of 50 μm or more are used. Therefore, the present invention makes it possible to use fillers having large particle diameter in the preparation of an adhesive, resulting in an increase in the flexibility of the adhesive. Accordingly, the adhesive of the present invention may be applied to not only a substrate having a rough surface but also electronic parts requiring large attachment area.

Particularly, the use of the thermally conductive, flame-retardant filler as the flame-retardant filler will provide a great improvement in the heat transfer efficiency of the adhesive upon application to electronic parts having large attachment area, for example, heat sink pads for plasma display panels. Namely, the use of thermally conductive flame-retardant fillers with a particle diameter of 50 μm or more can provide the desired thermal conductivity without the use of a separate thermally conductive filler since they are excellent in thermal conductivity. Also, since they are 50 μm or more in the particle diameter, they do not cause a significant increase in the viscosity of the adhesive, so as to make the processability of the adhesive excellent, leading to the easiness of preparation processes.

Accordingly, the application of the present invention can provide an adhesive which shows excellent processability in the preparation thereof and is excellent in flexibility.

Acrylic polymer resins which can be used in the present invention are not specifically limited, and any acrylic polymer resin used as an adhesive in the conventional art may be used without limitations. Preferred examples of the acrylic polymer resin include polymers formed by copolymerizing a (meth)acrylic ester monomer having an alkyl group of 1-12 carbon atoms with a polar monomer copolymerizable with the (meth)acrylic ester monomer.

Examples of the (meth)acrylic ester monomer having an alkyl group of 1-12 carbon atoms include, but are not limited to, butyl (meth)acrylate, hexyl (meth)acrylate, n-octyl (meth)acrylate, isooctyl (meth)acrylate, 2-ethylhexyl (meth)acrylate, and isononyl (meth)acrylate.

Also, examples of the polar monomer copolymerizable with the (meth)acrylic ester monomer include, but are not limited to, carboxyl group-containing monomers, such as (meth)acrylic acid, maleic acid and fumaric acid, or nitrogen-containing monomers, such as acrylamide, N-vinyl pyrrolidone and N-vinyl caprolactam. These polar monomers can act to provide cohesion property to the adhesive and to improve adhesion strength.

The ratio of the polar monomer to the (meth)acrylic ester monomer is not specifically limited and the amount of the polar monomer is preferably 1-20 parts by weight to the 100 parts by weight of the (meth)acrylic ester monomer taken as.

The adhesive of the present invention may be prepared using the above-described acrylic polymer resin and flame-retardant filler, and a crosslinker and a photoinitiator by any method known in the art.

As a polymerization method which can be applied for the preparation of the acrylic adhesive resin, radical polymerization, for example, solution polymerization, emulsion polymerization, suspension polymerization, photopolymerization and bulk polymerization, may be used. Preferably, the adhesive of the present invention can be prepared by partially polymerizing an acrylic resin for adhesives, and adding a flame retardant and other additives to the partially polymerized resin, then photopolymerizing and crosslinking the mixture.

The additives include, for example, a crosslinker and a photoinitiator, and if necessary, a foaming agent may further be added.

Specifically, monomers for forming the acrylic polymer resin, for example, a (meth)acrylic ester monomer having an alkyl group of 1-12 carbon atoms and a polar monomer which is copolymerizable with the (meth)acrylic ester monomer, are partially polymerized using a thermal initiator so as to prepare a polymer syrup having a viscosity of about 1,000-10,000 cps. To this polymer syrup, a flame-retardant filler or a thermally conductive flame-retardant filler and a photoinitiator are added so as to prepare slurry. Then, as an example to prepare an adhesive sheet, the slurry is applied on a sheet after which the applied slurry is polymerized and crosslinked by irradiation with ultraviolet light, thus preparing an adhesive sheet of the present invention.

It is preferred that the flame-retardant fillers or the thermally conductive flame-retardant fillers are uniformly distributed in the adhesive. Thus, it is preferred that the flame-retardant fillers or the thermally conductive flame-retardant fillers are added during the above preparation process and then sufficiently stirred and mixed so as to disperse the fillers uniformly in the resin.

In the above-described method of preparing the adhesive of the present invention, the adhesive properties of the adhesive may be adjusted depending on the amount of the crosslinker, and it is preferred to use the crosslinker at an amount of about 0.2-1.5 parts by weight to the 100 parts by weight of the acrylic polymer resin.

Examples of crosslinkers which can be used in the preparation of the present adhesive include, but are not limited to, monomeric crosslinkers, such as polyfunctional acrylates, for example, 1,6-hexanediol diacrylate, trimethylolpropane triacrylate, pentaerythritol triacrylate, 1,2-ethyleneglycol diacrylate and 1,12-dodecanediol acrylate.

Meanwhile, the photoinitiator can adjust not only the polymerization degree of the adhesive depending on the amount of use thereof but also the content of the unreacted residual monomers in the adhesive. Namely, an increase in the use amount of the photoinitiator leads to an increase in the polymerization conversion of the monomers during the UV light irradiation process, resulting in a reduction in the content of the unreacted residual monomers in the adhesive, thus improving the flame retardancy of the adhesive. However, the use of an excessive amount of the photoinitiator results in a shortening in the length of polymer chains, thus adversely affecting the high-temperature durability of the adhesive. Meanwhile, a reduction in the amount of use of the photoinitiator leads to a reduction in the polymerization degree of the monomers by the UV light irradiation, resulting in a relative increase in the content of the unreacted residual monomers in the adhesive.

Accordingly, it is necessary to use a suitable amount of the photoinitiator such that the content of the unreacted residual monomers in the adhesive is maintained at 2% or less by weight and that the high-temperature durability of the adhesive can be maintained. It is preferred in the present invention to use the photoinitiator at an amount of 0.3-2.0 parts by weight to the 100 parts by weight of the acrylic polymer resin.

Examples of photoinitiators which can be used in the present invention include, but are not limited to, 2,4,6-trimethylbenzoyldiphenylphosphin oxide, bis(2,4,6-trimethylbenzoyl)phenylphosphin oxide, α,α-methoxy-α-hydroxyacetophenone, 2-benzoyl-2-(dimethylamino)-1-[4-(4-morphonyl)phenyl]-1-butanone, and 2,2-dimethoxy-2-phenyl acetophenone.

In the polymerization and crosslinking processes by the ultraviolet light, a high intensity of ultraviolet light performs polymerization and crosslinking within a short time but causes an increase in the content of the unreacted residual monomers in the adhesive. Moreover, at a low intensity of ultraviolet light, the polymerization and crosslinking of the monomers occur slowly, but the content of the unreacted residual monomers in the adhesive is continuously reduced until the monomers reach a certain conversion ratio. In order to reach the above certain conversion ratio by the irradiation with a low intensity of ultraviolet light, long-term ultraviolet irradiation is required. Accordingly, the long-term irradiation of a low intensity of ultraviolet light allows a reduction in the content of the unreacted residual monomers in the adhesive.

It is preferred in the present invention that, in the polymerization and crosslinking processes by ultraviolet light, ultraviolet light with an intensity of about 0.01-50 mW/cm² is irradiated for 30 seconds to 1 hour.

Furthermore, the present invention provides a method of controlling the flame retardancy of an adhesive by adjusting the content of the unreacted residual monomers in the adhesive. Preferably, the content of the unreacted residual monomers in the adhesive which is prepared by the polymerization and crosslinking by the irradiation with ultraviolet light can be controlled by adjusting the irradiation intensity and irradiation time of the ultraviolet light.

Also, the present invention provides an adhesive sheet formed by applying the adhesive of the present invention to a sheet. The adhesive of the present invention can be applied to the sheet by any conventional method known in the art.

A preferred example of the adhesive sheet of the present invention is a thermally conductive adhesive sheet comprising thermally conductive flame-retardant fillers, and an illustrative embodiment of a method of preparing this thermally conductive adhesive sheet is as follows.

Monomers for forming the acrylic polymer resin, for example a (meth)acrylic ester monomer having an alkyl group of 1˜12 carbon atoms, and a polar monomer copolymerizable with the (meth)acrylic ester monomer, are partially polymerized by, for example, bulk polymerization, using a thermal initiator, so as to prepare a polymer syrup with a viscosity of 1,000-10,000 cps. To this polymer syrup, the above-described flame-retardant filler, crosslinker and photoinitiator are added, and the mixture is stirred so as to prepare a slurry having the flame-retardant fillers dispersed uniformly therein. Then, the slurry is applied to a substrate, and polymerized and crosslinked by irradiation with ultraviolet light, thus preparing an adhesive sheet. In the process of applying the mixture, the mixture can be applied to one or both sides of the substrate such that the adhesive of the present invention may be used as a one-side or both-side adhesive tape. The use of a thermally conductive flame-retardant filler as the flame-retardant filler allows the preparation of a thermally conductive adhesive sheet.

Examples of substrates which can be used as a sheet in the preparation of the adhesive sheet include plastics, paper, nonwoven fabrics, glass and metals. Preferably, a polyethylene terephthalate (PET) film can be used. The adhesive sheet of the present invention may be either used directly on substrates, such as heat sinks (heat-dissipating sheet), or provided as a portion of electronic parts.

The thickness of the adhesive sheet is not specifically limited but is preferably 50 μm-2 mm. A thickness smaller than 50 μm will cause a reduction in a heat transfer contact area with the outside, leading to a reduction in heat transfer efficiency, thus making it difficult to achieve a sufficient heat transfer between a heat-generating material and a heat-dissipating sheet and to secure sufficient adhesion. An adhesive sheet thickness lager than 2 mm will cause an increase in the thermal resistance of the adhesive sheet, and it takes much time to achieve heat dissipation.

The flame-retardant adhesive of the present invention may also contain additives, such as a pigment, an antioxidant, an UV stabilizer, a dispersant, a defoaming agent, a tackifier, a plasticizer, an adhesion-imparting resin, and a silane coupling agent, as long as they do not influence the effects of the present invention.

Also, the flame-retardant adhesive of the present invention may be foamed to obtain improved flexibility. Foaming methods which can be used in this case include a mechanical dispersion of bubbles by the injection of CO₂ or N₂ gas, a dispersion of polymeric hollow microspheres, and a use of thermal foaming agents.

According to the present invention, the content of the unreacted residual monomers in the adhesive is controlled to be 2% or less by weight by adjusting the kind and amount of the materials used in the preparation of the adhesive and preparation conditions, particularly the irradiation intensity and irradiation time of ultraviolet light in the polymerization and crosslinking processes. This allows the inventive adhesive to have not only excellent adhesion strength, thermal conductivity and flame retardancy but also easy processability.

### ADVANTAGEOUS EFFECTS

The present invention can provide an adhesive with excellent flame retardancy by reducing the content of the unreacted residual monomers in the adhesive to 2% or less by weight. Also, controlling the content of the unreacted residual monomers to 2% or less by weight allows an adhesive with excellent flame retardancy to be obtained even when flame-retardant fillers or thermally conductive flame-retardant fillers with a diameter of 50 μm or more are used. Accordingly, the present invention allows the use of fillers having relatively large particle diameter, thus making it possible to prepare an adhesive with excellent flexibility. If the adhesive of the present invention with excellent flexibility is used for the attachment of large-area devices, such as plasma display panels, the adhesion area between a heat-generating material and the external heat sink will be increased due to the improved flexibility of the adhesive, thus significantly improving the heat transfer efficiency therebetween. In addition, the viscosity of a slurry containing the adhesive resin is very suitable for coating when applied on a sheet, which makes the processability of the adhesive sheet excellent, thus allowing the preparation of a uniform adhesive sheet.

### MODE FOR CARRYING OUT THE INVENTION

Hereinafter, preferred examples are given for a better understanding of the present invention. It is to be understood, however, that these examples are presented for illustrative purpose only, but are not construed to limit the scope of the present invention.

### EXAMPLE 1

95 parts by weight of 2-ethylhexyl acrylate and 5 parts by weight of polar monomer acrylic acid were partially polymerized by heating (70° C.) in a 1-liter glass reactor to obtain a polymer syrup with a viscosity of 3500 cPs. In this Example and the following Examples, parts by weight are based on the weight of the adhesive polymer resin taken as 100 parts by weight. To the obtained the polymer syrup, 0.75 parts by weight of Irgacure-651 (α,α-methoxy-α-hydroxyacetophenone) as a photoinitiator, and 1.05 parts by weight of 1,6-hexanediol diacrylate (HDDA) as a crosslinker, were added, and the mixture was sufficiently stirred. To the stirred mixture, 100 parts by weight of aluminum hydroxide with a particle diameter of about 70 μm (obtained from Showa Denko Co., Japan) as a thermally conductive flame-retardant filler, were added, and the mixture was sufficiently stirred until the fillers were dispersed uniformly. This mixture was degassed by a vacuum pump under reduced pressure and then coated on a polyester release film to a thickness of 1 mm by knife coating. At this time, a polyester film was covered on the coating layer in order to block oxygen. Thereafter, the coating layer was irradiated with UV light by means of a UV light lamp with a UV light intensity of 1 mW/cm² for 5 minutes, thus obtaining a thermally conductive flame-retardant adhesive sheet.

### EXAMPLE 2

A thermally conductive flame-retardant adhesive sheet was obtained in the same manner as in Example 1 except that UV light irradiation was conducted using a UV light lamp with a UV light intensity of 1 mW/cm² for 30 minutes.

### EXAMPLE 3

A thermally conductive flame-retardant adhesive sheet was obtained in the same manner as in Example 1 except that UV light irradiation was conducted using a UV light lamp with a UV light intensity of 50 mW/cm² for 5 minutes.

### EXAMPLE 4

A thermally conductive flame-retardant adhesive sheet was obtained in the same manner as in Example 1 except that UV light irradiation was conducted using a UV light lamp with a UV light intensity of 50 mW/cm² for 30 minutes.

### EXAMPLE 5

A thermally conductive flame-retardant adhesive sheet was obtained in the same manner as in Example 1 except that magnesium hydroxide in place of aluminum hydroxide was used.

### EXAMPLE 6

A thermally conductive flame-retardant adhesive sheet was obtained in the same manner as in Example 1 except that calcium hydroxide in place of aluminum hydroxide was used.

### COMPARATIVE EXAMPLE 1

A thermally conductive flame-retardant adhesive sheet was obtained in the same manner as in Example 1 except that UV light irradiation was conducted using a UV light lamp with a UV light intensity of 100 mW/cm² for 5 minutes.

### COMPARATIVE EXAMPLE 2

A thermally conductive flame-retardant adhesive sheet was obtained in the same manner as in Example 1 except that UV light irradiation was conducted using a UV light lamp with a UV light intensity of 100 mW/cm² for 30 minutes.

### COMPARATIVE EXAMPLE 3

A thermally conductive flame-retardant adhesive sheet was obtained in the same manner as in Example 1 except that UV light irradiation was conducted using a UV light lamp with a UV light intensity of 250 mW/cm² for 5 minutes.

### COMPARATIVE EXAMPLE 4

A thermally conductive flame-retardant adhesive sheet was obtained in the same manner as in Example 1 except that UV light irradiation was conducted using a UV light lamp with a UV light intensity of 250 mW/cm² for 30 minutes.

### COMPARATIVE EXAMPLE 5

A thermally conductive flame-retardant adhesive sheet was obtained in the same manner as in Example 5 except that UV light irradiation was conducted using a UV light lamp with a UV light intensity of 100 mW/cm² for 30 minutes.

### COMPARATIVE EXAMPLE 6

A thermally conductive flame-retardant adhesive sheet was obtained in the same manner as in Example 6 except that UV light irradiation was conducted using a UV light lamp with a UV light intensity of 250 mW/cm² for 5 minutes.

The kind, diameter and amount of the fillers used in Examples and Comparative Examples, the amount of the photoinitiator, and the intensity and irradiation time of UV light, are shown in Table 1 below.

TABLE 1

| | | Diameter | Amount of | Amount of | Intensity of | Irradiation |
|---|---|---|---|---|---|---|
| | Kind of | of fillers | fillers | photoinitiator | UV light | time of UV |
| | fillers | (μm) | (weight part) | (weight part) | (mW/cm²) | light (minute) |
| Example 1 | Al(OH)₃ | 70 | 100 | 0.75 | 1 | 5 |
| Example 2 | Al(OH)₃ | 70 | 100 | 0.75 | 1 | 30 |
| Example 3 | Al(OH)₃ | 70 | 100 | 0.75 | 50 | 5 |
| Example 4 | Al(OH)₃ | 70 | 100 | 0.75 | 50 | 30 |
| Example 5 | Mg(OH)₂ | 70 | 100 | 0.75 | 1 | 5 |
| Example 6 | Ca(OH)₂ | 70 | 100 | 0.75 | 1 | 5 |
| Comparative | Al(OH)₃ | 70 | 100 | 0.75 | 100 | 5 |
| Example 1 | | | | | | |
| Comparative | Al(OH)₃ | 70 | 100 | 0.75 | 100 | 30 |
| Example 2 | | | | | | |
| Comparative | Al(OH)₃ | 70 | 100 | 0.75 | 250 | 5 |
| Example 3 | | | | | | |
| Comparative | Al(OH)₃ | 70 | 100 | 0.75 | 250 | 30 |
| Example 4 | | | | | | |
| Comparative | Mg(OH)₂ | 70 | 100 | 0.75 | 100 | 30 |
| Example 5 | | | | | | |
| Comparative | Ca(OH)₂ | 70 | 100 | 0.75 | 250 | 5 |
| Example 6 | | | | | | |

### TEST EXAMPLE 1

### Evaluation of Physical Properties According to the Contents of the Unreacted Residual Monomers

The physical properties of the thermally conductive flame-retardant adhesive sheets prepared in Examples and Comparative. Examples were evaluated in the following manner.

1. Peel Strength Test

The adhesion of each of the adhesive sheets to an aluminum sheet was measured on the basis of JISZ1541. Each of the adhesive sheets was left to stand at ambient temperature for 30 minutes.

2. Test of Thermal Conductivity

Each of the prepared adhesive sheets was cut into a sample size of about 60 mm×120 mm, and thermal conductivity of the samples were measured with the rapid thermal conductivity meter QTM-500 (Kyoto Electronics Manufacturing Co., Ltd, Japan).

3. Test of Content of Unreacted Residual Monomers

The results of GC-mass analysis on the unreacted residual monomers demonstrated that the unreacted residual monomers were 2-ethylhexyl acrylate and acrylic acid which have been present as monomers in the partially polymerized resin. The unreacted residual monomers are those that have not entered into the polymer structure during the preparation process of the adhesive, and are generally extracted either by the application of heat or under a vacuum atmosphere for the measurement of their content and component analysis. In the present invention, a method of extracting monomers by the application of heat was used. Specifically, the extraction was performed in the following manner.

Each of the prepared adhesive sheets was cut into a size of about 30 mm×30 mm and attached to release paper cut into a size of 50 mm×50 mm to make a sample. Then, each sample was maintained in an oven at 110° C. for 1 hour and then measured change of weight before and after introducing the sample into the oven. The measured weight change was expressed as the content of the remaining monomers which had not been reacted upon irradiation with UV light.

4. Flame Retardancy Test

Each of the prepared adhesive sheets was subjected to a burning test based on the UL94V standards, and its flame retardancy grade was rated. Detailed test was as follows.

To rate the flame retardancy grade, the following measurements were performed: the sum of the first and second burning time and the fire-extinguishing time for each sample, the sum of the first and second burning time for a set of five samples, and the ignition of cotton by the dropping of a flame. Each of the test samples was 0.5 inches in width and 5 inches in length. In the test method, a single flame (methane gas blue flame, 3/4 inch high) was applied to the test sample for 10 seconds and then removed. When burning ceased, a flame was re-applied for an additional 10 seconds and then removed. The flame-retardancy grade was rated on the basis of Table 2 below.

TABLE 2

| | Sum of first and | Sum of first | Ignition |
|---|---|---|---|
| | second burning | and second | of cotton |
| | time and spark- | burning time | by dropping |
| | extinguishing time | for five samples | of flame |
| V-0 | Less than 10 seconds | Less than 50 seconds | No |
| V-1 | Less than 30 seconds | Less than 250 seconds | No |
| V-2 | Less than 30 seconds | Less than 250 seconds | Yes |

The results of physical property measurement by the above method are shown in Table 3 below.

TABLE 3

| | Peel | Thermal | Residual | |
|---|---|---|---|---|
| | Strength | conductivity | monomer | Flame |
| | (g/in) | (W/mK) | content (%) | retardancy |
| Example 1 | 935 | 0.45 | 1.3 | V-1 |
| Example 2 | 1228 | 0.46 | 0.9 | V-0 |
| Example 3 | 904 | 0.44 | 1.8 | V-2 |
| Example 4 | 1033 | 0.45 | 1.1 | V-0 |
| Example 5 | 911 | 0.48 | 0.9 | V-0 |
| Example 6 | 1016 | 0.42 | 1.5 | V-2 |
| Comparative | 657 | 0.43 | 3.1 | No |
| Example 1 | | | | |
| Comparative | 769 | 0.45 | 2.9 | No |
| Example 2 | | | | |
| Comparative | 541 | 0.44 | 4.2 | No |
| Example 3 | | | | |
| Comparative | 808 | 0.45 | 3.7 | No |
| Example 4 | | | | |
| Comparative | 598 | 0.48 | 2.6 | No |
| Example 5 | | | | |
| Comparative | 735 | 0.41 | 4.2 | No |
| Example 6 | | | | |

As can be seen in the Table above, the 1 mm-thick adhesive sheets prepared in Examples of the present invention all showed flame retardancy. Also, from the measurement results of the 180′-direction adhesion to an aluminum sheet, it could be found that the adhesive sheets of the present invention showed a high peel strength of more than 900 g/in.

Furthermore, from the measurement results of the thermal conductivity of the 1 mm-thick adhesive sheets according to the present invention, it could be found that the adhesive sheets of the present invention showed a good thermal conductivity of more than 0.40 W/mK.

### TEST EXAMPLE 2

In order to evaluate physical properties at different particle sizes of a thermally conductive flame-retardant filler, the following test was performed.

Specifically, thermally conductive flame-retardant adhesives were prepared using aluminum hydroxide particles as the thermally conductive flame-retardant filler, in the same manner as in Example 1 except that the aluminum hydroxide particles had different sizes of 1.0 μm, 3.5 μm, 10 μm, 55 μm and 100 μm, and the prepared adhesives were named “reference examples 1-5”, respectively. Meanwhile, aluminum hydroxide particles with a size of more than 150 μm showed severe precipitation so that they were not easy to prepare an adhesive and were unsuitable to carry out this test.

Moreover, for comparison with the physical properties of an adhesive from which the unreacted residual monomers had been removed by burning after the preparation of the adhesive, a thermally conductive flame-retardant adhesive sheet was prepared in the same manner as in Comparative Example 3 and then heated at 150° C. for 30 minutes so as to remove the unreacted residual monomers. The prepared adhesive sheet was named “reference example 6”.

The physical properties of the adhesives according to these reference examples were evaluated as follows. The adhesives were tested for peel strength, thermal conductivity, the content of the unreacted residual monomers, and flame retardancy in the same manner as in Test Example 1. Also, to evaluate processability, the viscosity of a slurry comprising a partially polymerized acrylate syrup mixed with aluminum hydroxide was measured before conducting UV light curing (see Example 1). In the present invention, a Brookfield viscometer was used to measure the slurry viscosity so as to evaluate processability before coating the adhesive slurry. For reference, the most suitable slurry viscosity to make thickness uniform and to increase coating rate is 20,000-40,000 cPs.

The results are shown in Table 4 below.

TABLE 4

| | | | Residual | | |
|---|---|---|---|---|---|
| | Peel | Thermal | monomer | Flame | Slurry |
| | Strength | conductivity | content | retar- | viscosity |
| | (g/in) | (W/mK) | (%) | dancy | (cps) |
| Reference | 866 | 0.42 | 0.8 | V-0 | 100,100 |
| example 1 | | | | | |
| Reference | 878 | 0.42 | 0.8 | V-0 | 91,500 |
| example 2 | | | | | |
| Reference | 899 | 0.43 | 0.9 | V-0 | 68,300 |
| example 3 | | | | | |
| Reference | 921 | 0.44 | 1.1 | V-0 | 34,500 |
| example 4 | | | | | |
| Reference | 989 | 0.48 | 1.3 | V-1 | 23,800 |
| example 5 | | | | | |
| Reference | 233 | 0.43 | 1.6 | V-2 | 26,700 |
| example 6 | | | | | |

As can be seen in the above result, the adhesive sheet of the present invention showed a flame retardancy superior to V-2 level in the burning test based on the UL94V standards even when flame-retardant filler particles with a size of 50 μm or more were used. Also, since the size of the flame-retardant filler particles was 50 μm or more, the slurry in the preparation of the adhesives was maintained at a viscosity of 20,000-40,000 cps, the most suitable viscosity for coating. This suggests that the slurry makes it possible to prepare adhesives with uniform thickness and physical properties and has excellent processability.

Meanwhile, the adhesive sheet of reference example 6, which had been obtained by heating the thermally conductive flame-retardant adhesive sheet prepared as described in Comparative Example 3 so as to reduce the content of the unreacted residual monomers showed an improvement in flame retardancy due to a reduction in the content of the unreacted residual monomers. However, it is difficult for this adhesive sheet to be used as an actual product due to a change in its physical properties caused by heating at high temperature. Accordingly, in the prior art, the content of the unreacted residual monomers is controlled by heating or hot air circulation drying but this causes a change in the physical properties of adhesive products. Thus, it is preferred to minimize the content of the unreacted residual monomers in adhesive products by the selection of suitable UV light intensity and flame-retardant fillers as described in the present invention.

### INDUSTRIAL APPLICABILITY

As described above, the adhesive of the present invention having excellent adhesion strength, thermal conductivity and flame retardancy can be easily used for the attachment of those requiring both thermal conductivity and flame retardancy. In particular, the adhesive of the present invention can be widely used in electronic products. For example, the adhesive of the present invention will be useful as a thermally conductive adhesive which acts to transfer heat generated in heat-generating materials to heat sinks in electronic parts, such as plasma display panels with strict performance requirements, while supporting the heat-generating materials and the heat sinks.

1. An adhesive with flame retardancy, comprising an acrylic polymer resin and a flame-retardant filler, wherein the content of unreacted residual monomers in the adhesive, which are parts of monomers for forming the acrylic polymer resin and remain unreacted after a preparation process of the adhesive, is 2% or less by weight.

2. The adhesive of claim 1, wherein the flame-retardant filler is a thermally conductive flame-retardant filler.

3. The adhesive of claim 2, wherein the thermally conductive flame-retardant filler has a particle diameter of 50-150 μm.

4. The adhesive of claim 2, wherein the thermally conductive flame-retardant filler is metal hydroxide.

5. The adhesive of claim 4, wherein the metal hydroxide is selected from the group consisting of aluminum hydroxide, magnesium hydroxide, and calcium hydroxide.

6. The adhesive of claim 2, wherein the thermally conductive flame-retardant filler is contained in the adhesive at an amount of 80-150 parts by weight to the 100 parts by weight of the acrylic polymer resin.

7. The adhesive of claim 1, wherein the acrylic polymer resin is a polymer formed by copolymerizing (meth)acrylic ester monomers having an alkyl group of 1-12 carbon atoms with polar monomers copolymerizable with the (meth)acrylic ester monomers.

8. The adhesive of claim 7, wherein the (meth)acrylic ester monomers are selected from the group consisting of butyl (meth)acrylate, hexyl (meth)acrylate, n-octyl (meth)acrylate, isooctyl (meth)acrylate, 2-ethylhexyl (meth)acrylate, and isononyl (meth)acrylate,
the polar monomers are selected from the group consisting of (meth)acrylic acid, maleic acid, fumaric acid, acrylamide, N-vinyl pyrrolidone and N-vinyl caprolactam, and
the polar monomers are contained at an amount of 1-20 parts by weight to the 100 parts by weight of the (meth)acrylic ester monomer.

9. A method for preparing an adhesive by polymerizing and crosslinking a mixture comprising monomers for forming an acrylic polymer resin, polar monomers copolymerizable with said monomers, and a flame-retardant filler,
wherein the mixture is polymerized and crosslinked until the content of unreacted residual monomers in the adhesive, which are parts of the monomers for forming the acrylic polymer resin and remain unreacted, is 2% or less by weight to the weight of the adhesive.

10. The method of claim 9, wherein the polymerization is performed by irradiation with ultraviolet light with an intensity of 0.01-50 mW/cm² for 30 seconds to 1 hour.

11. The method of claim 10, which further comprises, before the irradiation with ultraviolet light, adding a photoinitiator at an amount of 0.3-2.0 parts by weight to 100 parts by weight of the mixture of the monomers for forming the acrylic polymer resin and the polar monomers copolymerizable with said monomers.

12. The method of claim 11, wherein the photoinitiator is selected from the group consisting of 2,4,6-trimethylbenzoyldiphenylphosphin oxide, bis(2,4,6-trimethylbenzoyl)phenylphosphin oxide, α,α-methoxy-α-hydroxyacetophenone, 2-benzoyl-2-(dimethylamino)-1-[4-(4-morphonyl)phenyl]-1-butanone, and 2,2-dimethoxy-2-phenyl acetophenone.

13. The method of claim 10, which further comprises, before the irradiation with ultraviolet light, partially polymerizing the monomers for forming the acrylic polymer resin.

14. A method of controlling the flame retardancy of an adhesive prepared by polymerizing and crosslinking a mixture comprising monomers for forming an acrylic polymer resin, polar monomers copolymerizable with said monomers, and a flame-retardant filler, which comprises controlling the content of unreacted residual monomers that are parts of the monomers for forming the acrylic polymer resin and remain unreacted.

15. The method of claim 14, wherein the polymerization and crosslinking processes are performed by irradiation with ultraviolet light, and the content of the unreacted residual monomers is controlled by adjusting the intensity of ultraviolet light in the polymerization and crosslinking processes.

16. The method of claim 15, wherein the intensity of ultraviolet light is adjusted to 0.01-50 mW/cm² and irradiation time of ultraviolet light is adjusted to 30 seconds to 1 hour.

17. An adhesive sheet formed by applying the adhesive according to claim 1 one or both sides of a substrate.

18. The adhesive sheet of claim 17, wherein the substrate is selected from the group consisting of plastics, paper, non-woven fabrics, glass, and metals.
